(19) United States
(12) Patent Application Publication
(10) Pub. No.: US 2008/0295897 A1
(43) Pub. Date: Dec. 4, 2008

(54) DUAL RANGE FLOW SENSOR

(76) Inventor: Raymond A. Vincent, Plymouth, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/755,767

(22) Filed: May 31, 2007

(51) Int. Cl. F16K 31/00

(52) U.S. Cl. 137/488

(57) ABSTRACT

A fluid control apparatus includes a first sensor device for indicating a fluid flow within a first conduit that receives the fluid flow during a first condition and a second sensor device for indicating the fluid flow within a second conduit that receives the fluid flow during a second condition. In another example, the fluid control apparatus includes a member having a first surface and a second surface and an opening connecting the first surface and the second surface. The member moves between first and second positions during a first condition and the opening receives a fluid flow during a second condition. The first and second conditions correspond to a pressure differential.

### BACKGROUND OF THE INVENTION

This invention relates to water flow control and, more particularly, to a device that detects low flow associated with a leak and normal flow associated with desired uses.

Residential and commercial structures typically include water supply lines that receive water from a remote water supply source and transport the water to a desired end use. The end use may be a faucet, water heater, toilet, or other water use for example. Often, the residential or commercial structure may be left unattended or the water supply lines may not be closely monitored. If there is a leak during a time when the structure is unattended or not closely monitored, the leak may cause flooding and water damage to the structure and its contents.

Accordingly, there is a need for a flow control device that utilizes a water usage pattern and detection of low flow rates associated with a leak condition to monitor the water supply lines for leaks. This invention addresses those needs and provides advanced capabilities while avoiding the shortcomings and drawbacks of the prior art.

### SUMMARY OF THE INVENTION

The fluid control apparatus includes a first sensor device for indicating a water flow within a first conduit that receives the water flow during a first condition and a second sensor device for indicating the water flow within a second conduit that receives the water flow during a second condition. In one example, the first condition corresponds to a pressure differential that exceeds a pressure threshold and the second condition corresponds to a pressure differential that is below the pressure threshold.

In another example, the fluid control apparatus includes a member having a first surface and a second surface and an opening connecting the first surface and the second surface. The member moves between first and second positions during the first condition and the opening receives a water flow during the second condition. The opening receives the water flow when a pressure differential is below a pressure threshold and the member moves between first and second positions when the pressure differential is above the pressure threshold.

A method of fluid control includes determining a fluid usage pattern based upon water flow through a water supply line, monitoring the water supply line to detect a flow rate that corresponds to a leak condition, and controlling the water flow through the water supply line based upon the fluid usage pattern and the leak condition.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows.

FIG. 1 shows selected portions of an example water system.

FIG. 2 shows selected portions of an example fluid monitoring device.

FIG. 3 shows selected portions of the example fluid monitoring device of FIG. 2 with the valve member in an open position.

FIG. 4 shows selected portions of the example fluid monitoring device of FIG. 2 with water flowing through a secondary conduit.

### DETAILED DESCRIPTION OF THE PREFERRED EMBODIMENT

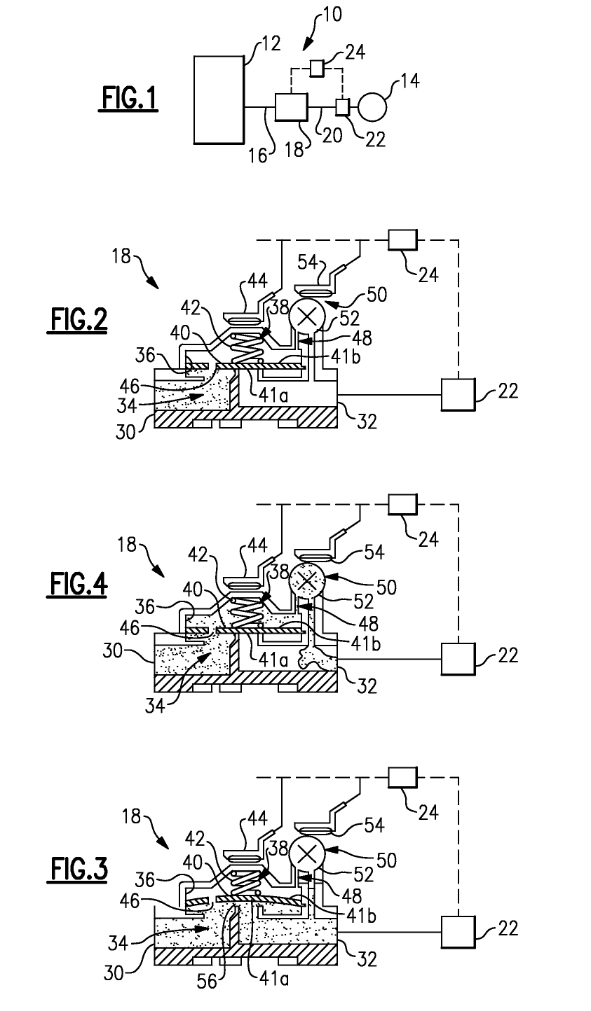

FIG. 1 shows selected portions of an example water system 10 that includes a water supply source 12 that supplies water to a water use 14 in a commercial, residential, or other structure for example. A first supply line 16 receives water from the water supply source 12 and transports the water to a fluid monitoring device 18. The water leaves the fluid monitoring device 18 through a second supply line 20 and is received by the water use 14, a faucet, water-heater, toilet, or other water use for example. The second supply line 20 includes a shut-off valve device 22 that is in communication with the fluid monitoring device 18 through a controller 24.

FIGS. 2-4 show selected portions of the example fluid monitoring device 18 during various operational states. The fluid monitoring device 18 includes an inlet portion 30 connected to the first supply line 16 and an outlet portion 32 connected to the second supply line 20. A main conduit 34 connects to inlet portion 30 and includes a chamber 36 in which a first sensor device 38 operates.

The first sensor device 38 includes a resilient valve member 40 having opposing surfaces 41a and 41b. The resilient valve member 40 moves between a closed position as illustrated in FIG. 2 and an open position as illustrated in FIG. 3. The resilient valve member 40 is coupled to a bias member 42, such as a spring, that urges the resilient valve member 40 to the closed position. The bias member 42 is operatively connected to a first sensor 44 such that water pressure applied to the resilient valve member 40 moves the resilient valve member 40 against a bias member 42, as will be described in more detail below. The movement of the resilient valve member 40 is detected by the first sensor 44.

In one example, the first sensor 44 includes a proximity sensor switch, reed switch sensor, or other type of sensor that indicates a first signal when the resilient valve member 40 is in the closed position and indicates a second signal when the resilient valve member 40 is in the open position. In another example, the first sensor 44 measures the magnitude of flow of water through the main conduit 34 and indicates a signal that corresponds to the magnitude.

The resilient valve member 40 includes an opening 46 that connects the inlet portion 30 to a secondary conduit 48. The secondary conduit 48 includes a second sensor device 50 such that water flow through the secondary conduit 48 moves a magnetic turbine 52 of the second sensor device 50. Actuation of the magnetic turbine 52 is detected by a second sensor 54.

In one example, the second sensor 54 indicates a first signal when water flows in the secondary conduit 48 and indicates a second signal when there is no water flow in the secondary conduit 48. In another example, the second sensor 54 measures the magnitude of flow of water through the secondary conduit 48 and indicates a signal that corresponds to the magnitude.

In another example, the second sensor device detects flow in a first flow rate range and the first sensor 44 detects flow rates within a second flow rate range. The detectable flow rate range of the second sensor 54 includes flow rates that are not within the detectable flow rate range of the first sensor 44. These features may provide the fluid monitoring device 18 with the benefit of sensing the fluid flow over a wider range of flow rates than previously known monitoring devices.

The area of the opening 46 is sized to permit water to flow through the opening 46 and into the secondary conduit 48 when the pressure differential (e.g. an air pressure differential) between the inlet portion 30 and the outlet portion 32 is between a first pressure threshold and a second, lower pressure threshold. Below the second, lower pressure threshold no water flows through the opening 46.

The second pressure threshold corresponds to a leak condition in the water system 10. That is, the leak condition produces a low pressure condition downstream of the fluid monitoring device in the second supply line 20 and at the outlet portion 32. A non-equilibrium state is created wherein the pressure at the inlet portion 30 is higher than the pressure at the outlet portion 32. When the difference between the pressures at the inlet portion 30 and outlet portion 32 exceeds the lower, second pressure threshold, water is forced through the opening 46. In one example, when the pressure differential exceeds the first pressure threshold, the resilient valve member 40 moves against the bias force of the bias member 42. Water may still flow through the opening 46 when the resilient valve member 40 moves, however, a most of the water will flow through a main conduit opening 56 to the outlet portion 32.

In one example, a slight leak condition, such as a leak on the order of under 100 cubic centimeters per minute, causes a pressure differential that is too small to move the resilient valve member 40 against the bias member 42 but large enough to urge water through the opening 46. It is to be appreciated that the size of the opening 46 controls the size of leak that can be detected.

The first sensor 44 and second sensor 54 communicate the respective signals to a controller 24. In one example, the controller 24 commands the shut-off valve device 22 to close and prevent water flow through the second supply line 20 when the signal from the second sensor 54 indicates water flow through the secondary conduit 48. This feature may provide the benefit of preventing water from continuing to flow through the second supply line 20 when there is a leak in the water system 10.

In another example, the controller 24 receives the signals from the first sensor 44 and determines a normal water use pattern based upon the signals. The terminology normal water use pattern as used in this description refers to desired uses of water (e.g. turning on of a faucet, flushing a toilet, etc.) and the times of day that the desired uses typically occur. In one illustrative example, the controller determines that a normal water use pattern includes a range of 7 a.m. to 7 p.m. and that any water use from 7:01 p.m. to 6:59 a.m. is outside of the normal water use pattern.

The controller uses the normal water use pattern in combination with signals from the second sensor 54 to determine whether there is a leak in the water system 10. When the controller 24 determines that there is water flow during a time outside of the normal water use pattern, the controller 24 commands the shut-off valve device 22 to close. When the controller 24 determines that there is water flow through the secondary conduit 48, the controller 24 also commands the shut-off valve device 22 to close. This may provide the benefit of detecting various types of leak conditions, such as large leaks occurring during atypical use times, small leaks occurring during atypical use times, small leaks occurring during typical use times, etc.

In another example, the controller additionally uses a duration of time that the water flow occurs to determine whether there is a leak.

In one operational example having no leak condition and no water turned on (e.g. a faucet is closed/off), water is received by the inlet portion 30 and exerts a water pressure on the resilient valve member 40. The pressure differential between the inlet portion 30 and outlet portion 32 (which corresponds to the water pressure on the resilient valve member 40) is not high enough to create a water pressure that moves the resilient valve member 40 against the bias member 42. Thus, the water is stopped by the resilient valve member 40 and does not flow through to the outlet portion 32 and second supply line 20.

When the downstream water use 14 is turned on, the pressure differential between the inlet portion 30 and the outlet portion 32 exceeds the first pressure threshold and moves the resilient valve member 40 against the bias force of the bias member 42. When the resilient valve member 40 moves upwards within the chamber 36, the main conduit opening 56 provides a fluid connection between the inlet portion 30 and the outlet portion 32 such that the water flows through to the outlet portion 32 and second supply line 20, as illustrated in FIG. 3.

In another operational example having a leak condition, the opening 46 is sized such that a small pressure differential created by the leak condition urges the water to flow through the opening 46 without moving the resilient valve member 40, although it is to be appreciated that the pressure differential may also create a water pressure high enough to slightly move the resilient valve member 40. The water that flows through the opening 46 flows through the chamber 36 and to the secondary conduit 48 and is detected by the second sensor device 50. The water exits the secondary conduit 48 to the outlet portion 32 and into the second supply line 20.

It is to be appreciated that the configuration of the fluid monitoring device 18 may provide the benefit of allowing the first sensor device 38 to function without interference from the operation of the second sensor device 50 and the second sensor device 50 to function without interference from the operation of first sensor device 38. This may provide the additional advantage of increased reliability from utilizing both a normal water usage pattern and detection of leak flow rates to monitor a water supply system.

Although a preferred embodiment of this invention has been disclosed, a worker of ordinary skill in this art would recognize that certain modifications would come within the scope of this invention. For that reason, the following claims should be studied to determine the true scope and content of this invention.

We claim:

1. A fluid control apparatus comprising:
a first sensor device for indicating a fluid flow within a first conduit that receives the fluid flow in association with a first condition; and
a second sensor device for indicating the fluid flow within a second conduit that receives the fluid flow in association with a second condition.

2. The apparatus as recited in claim 1, wherein said first condition corresponds to a pressure differential that exceeds a pressure threshold and said second condition corresponds to a pressure differential that is below the pressure threshold.

3. The apparatus as recited in claim 1, wherein said first sensor device indicates a flow magnitude of the fluid flow and said second sensor device indicates whether or not there is fluid flow.

4. The apparatus as recited in claim 1, including a controller that receives signals from said first sensor device and said second sensor device when said first sensor device and said second sensor device respectively indicate said fluid flow.

5. The apparatus as recited in claim 4, including a valve moveable between at least open and closed positions based upon commands from said controller.

6. The apparatus as recited in claim 4, wherein said commands are based upon a determined fluid usage pattern.

7. A fluid control apparatus comprising:
a member for controlling a fluid flow, said member including a first surface and a second surface, and said member moving between first and second positions during a first condition;
an opening connecting said first surface and said second surface, wherein said opening receives the fluid flow during a second condition.

8. The apparatus as recited in claim 7, wherein said first condition corresponds to a pressure differential that exceeds a pressure threshold and said second condition corresponds to a pressure differential that is below the pressure threshold and said fluid flow through said opening is indicative of a downstream leak condition.

9. The apparatus as recited in claim 8, wherein said opening receives the fluid flow when said pressure differential is between said pressure threshold and a lower, second pressure threshold.

10. The apparatus as recited in claim 9, wherein said opening is sized to permit fluid flow there through when the fluid flow is below said pressure threshold and to prevent fluid flow there through when the fluid flow is below said lower, second pressure threshold.

11. The apparatus as recited in claim 7, wherein said member includes a valve member that moves between said first and second positions to respectively open and close fluid flow between a fluid inlet portion and a fluid outlet portion.

12. The apparatus as recited in claim 7, wherein said member includes a resilient member, and said opening is formed in said resilient member.

13. The apparatus as recited in claim 7, including a first sensor that indicates movement of said member and a second sensor that indicates fluid flow through said opening.

14. The apparatus as recited in claim 13, wherein said member is within a first conduit and said second sensor is within a second conduit, and said first conduit fluidly connects to a fluid outlet portion when said member is in said first position and connects to said second conduit when the member is in said second position.

15. A method of fluid control comprising:
(a) determining a fluid usage pattern based upon fluid flow through a first conduit;
(b) monitoring a second conduit to detect a flow that corresponds to a leak condition; and
(c) controlling the fluid flow based upon at least one of the fluid usage pattern and the leak condition.

16. The method as recited in claim 15, wherein the step (a) includes detecting fluid flow that corresponds to desired fluid uses to establish the fluid usage pattern.

17. The method as recited in claim 16, wherein the step (a) includes detecting the fluid flow by moving the fluid through a first conduit when a fluid flow rate is within a first flow range and the step (b) includes detecting the flow by moving the fluid through a second conduit when the fluid flow rate is within a second, different flow range.

18. The method as recited in claim 17, including producing a first signal to indicate the fluid flow through the first conduit and producing a second signal to indicate fluid flow through the second conduit.

19. The method as recited in claim 18, including determining a magnitude of the fluid flow based upon one of the first signal and the second signal.

20. The method as recited in claim 15, wherein the step (c) includes closing a valve to stop the fluid flow based upon at least one of detection of fluid flow during a time outside of the fluid usage pattern or detection of the flow that corresponds to the leak condition.
